(19) United States
(12) Patent Application Publication
(10) Pub. No.: US 2009/0150774 A1
(43) Pub. Date: Jun. 11, 2009

(54) METHOD OF ORGANIZING APPLICATION SPECIFIC DOCUMENTS BASED ON DOCUMENT ATTRIBUTES

(75) Inventors: Kimilee S. Gile, Leominster, MA (US); Elaine I. Kuo, North Chelmsford, MA (US); Fang Lu, Billerica, MA (US); Corey S. McCaffrey, Boston, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/953,995

(22) Filed: Dec. 11, 2007

(51) Int. Cl. G06F 3/00

(52) U.S. Cl. 715/700

(57) ABSTRACT

A method of organizing application-specific documents of a computer system includes receiving a user-based selection of at least one document attribute through an application residing on a processor of the computer system, searching currently open documents within the application to locate documents associated with the at least one document attribute, organizing a first attribute group based on results of the searching, and graphically representing the first attribute group as a group of application-specific documents. The searching includes retrieving status information from the currently open documents and the organizing includes categorizing documents associated with the at least one document attribute and grouping the categorized documents as the first attribute group.

### TRADEMARKS

IBM® is a registered trademark of International Business Machines Corporation, Armonk, N.Y. U.S.A. Other names used herein may be registered trademarks, trademarks or product names of International Business Machines Corporation or other companies.

### BACKGROUND

1. Technical Field

This invention generally relates to organization of documents. More particularly, this invention relates to organizing application specific documents based on document attributes.

2. Description of Background

Generally, users of computer systems employ several applications at any time. Furthermore, users may have a plurality of documents open or active for any given application. The states of each of the plurality of documents may vary. For example, if a user is manipulating several of the documents, some of the documents may have new changes, others may have been changed but recently saved, etc. If the user manipulates the documents in series, and stores the documents before manipulating subsequent documents, any recent edits may be stored safely. However, as the number of documents being manipulated increases, and if the user manipulates documents in parallel, it may become cumbersome ensuring all recent edits are stored before closing an application or shutting the computer system down. Further, if there is an unscheduled power-outage or if the user leaves the computer system terminal for any amount of time, the user may become unaware of the status of the documents.

### SUMMARY

A method of organizing application-specific documents of a computer system includes receiving a user-based selection of at least one document attribute through an application residing on a processor of the computer system, searching currently open documents within the application to locate documents associated with the at least one document attribute, organizing a first attribute group based on results of the searching, and graphically representing the first attribute group as a group of application-specific documents. The searching includes retrieving status information from the currently open documents and the organizing includes categorizing documents associated with the at least one document attribute and grouping the categorized documents as the first attribute group.

Additional features and advantages are realized through the techniques of the exemplary embodiments described herein. Other embodiments and aspects of the invention are described in detail herein and are considered a part of the claimed invention, for a better understanding of the invention with advantages and features, refer to the detailed description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary user interface, according to an exemplary embodiment;

FIG. 2 illustrates an exemplary user interface, according to an exemplary embodiment;

FIG. 3 illustrates an exemplary user interface, according to an exemplary embodiment;

FIG. 4 illustrates a flowchart of a method for organizing documents, according to an exemplary embodiment; and

FIG. 5 illustrates a computer apparatus, according to an exemplary embodiment.

The detailed description explains an exemplary embodiment, together with advantages and features, by way of example with reference to the drawings.

### DETAILED DESCRIPTION

According to an exemplary embodiment, a method is provided which significantly increases the flexibility of visualizing application specific documents. The method provides for organizing documents based on at least one document attribute. The at least one document attribute is a user-specified option, further increasing flexibility. These increases in flexibility decrease the complexity of understanding the status of currently active application specific documents in a computer system.

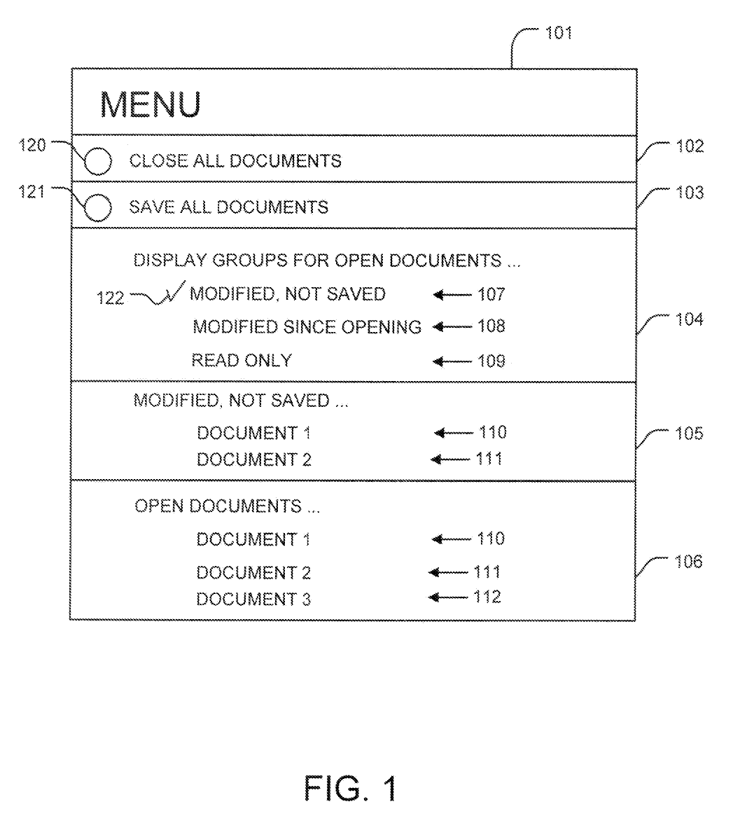

Turning to FIG. 1, an exemplary user interface 101 is illustrated. The user interface 101 may be a menu of an application residing on a processor of a computer apparatus. The user interface 101 includes attribute selection portion 104. Attribute selection portion 104 allows for user selection of a defined or desired set of document attributes. For example, document attributes may be the status of a document, stored by an application, representing the state of a document, or a file storing the document. Document attributes may include, but are not limited to, document modified but not saved (see 107), document modified since opened (see 108), document read only or write-protected (see 109), or other suitable attributes. A user may select one or more attributes within attribute selection portion 104, and each selection (or de-selection) may be represented by the presence (or absence) or a check-mark or other suitable graphical marking or highlight (see 122).

If a user selects a document attribute from attribute selection portion 104, exemplary embodiments organize documents associated with the selected attribute, and graphically represent them. In at least one exemplary embodiment, the graphical representation is a list (e.g., list portion 105). As shown in attribute selection portion 104, the “modified, not saved” attribute is selected for example purposes. As such, an example listing of documents associated with this attribute are listed in a list portion named “Modified, not saved . . . ” (see 105). In this example, documents one and two are modified but have not been saved. It is noted that if the attribute were not to be selected, the listing portion 105 would not be displayed. Also appearing in user interface 101 is open documents portion 106. Open documents portion 106 provides a graphical representation of all open documents of a particular application (see 110, 111, and 112). Also included in user interface 101 are close documents and save documents portions 102 and 103 with control buttons 120 and 121. It is noted that alternate controls may also be used, and thus exemplary embodiments should not be limited to only buttons.

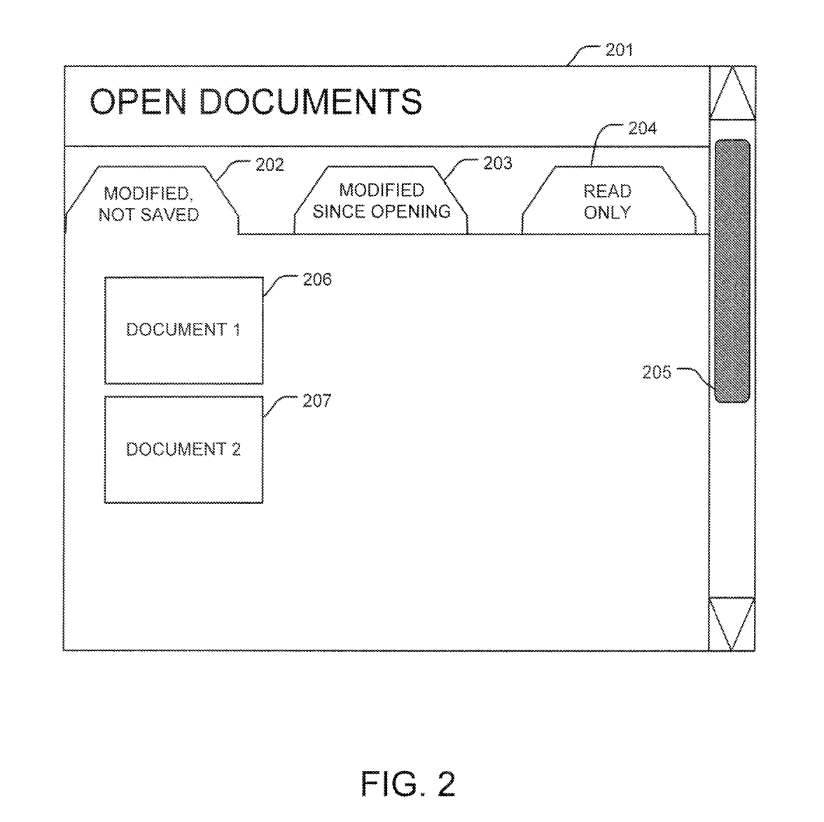

Therefore, as discussed above, exemplary embodiments, provide a user interface to organize application specific documents based on a user selected attribute. The organization is represented graphically, and in the previous example, is a list. However, exemplary embodiments are not so limited. Turning to FIG. 2, an alternate user interface 201 according to exemplary embodiments is illustrated.

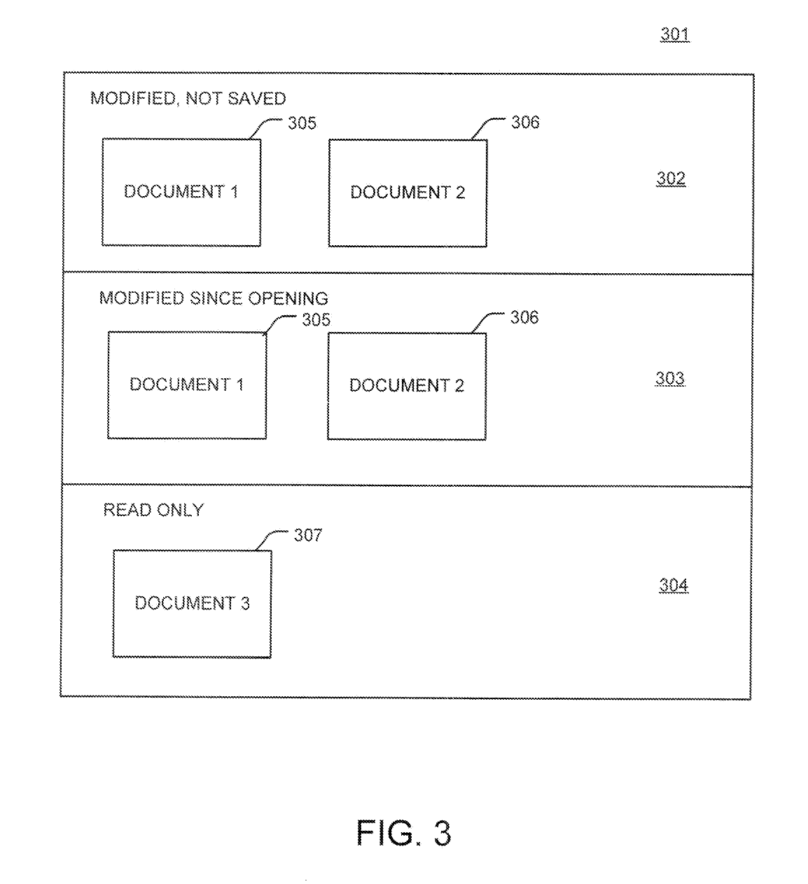

As illustrated, user interface 201 is tab-interface including user-selectable tabulated lists (see 202, 203, and 204) of documents (see 206 and 207). For example, as a user-selectable attribute, a user may click or select a tab representing an attribute. The attribute may be displayed as text on the tab of the tab-interface. If a tab is selected, exemplary embodiments organize documents associated with the attribute of the selected tab and represent the documents graphically on the tab display. For example, the documents may be displayed as a tabulated list, in a grid, as icons, etc. Furthermore, if the list, grid, or other representation is too large to display in the user interface, scroll portion 205 may be provided to allow the user to “scroll” through the representation to view all documents of a particular attribute. It is further noted that exemplary embodiments are not limited to only listings and tabular representations. As illustrated in FIG. 3, a user interface 301 provides a completely graphical representation of application specific documents.

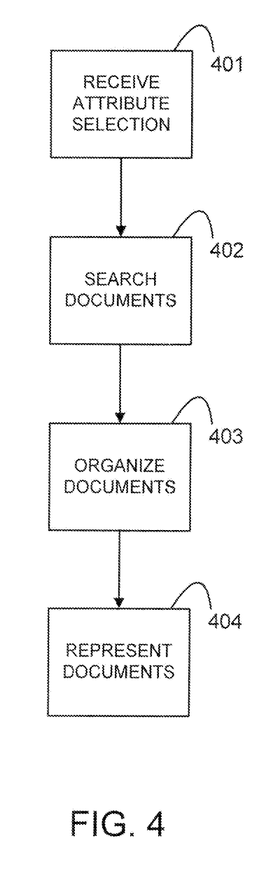

User interface 301 includes, for example, attribute portions 302, 303, and 304. Each attribute portion includes organized representations of documents associated with each attribute (see 305, 306, and 307). It is noted that one or more of the portions 302, 303, and 304 may be displayed simultaneously or individually. For example, a user may select a particular attribute through a selectable user interface (not shown), or through depression of a “hot-key” or shortcut key combination for a particular document attribute. Therefore, exemplary embodiments provide complete graphical organization as well as tabular and listing representations. Hereinafter, a method for organizing application specific documents 400 is described with reference to FIG. 4.

The method 400 includes receiving a user-based selection of at least one document attribute at block 401. For example, the user may select a document attribute through an application residing on a processor of a computer system. The application may have several documents open, with each document of the several documents being associated with different attributes. A status of each document is stored as a binary flag or and integer value in a portion of the source code residing on the processor. Therefore, exemplary embodiments have access to the status of documents, and therefore may compare attributes for organization of documents.

The method 400 further includes searching currently open documents within the application at block 402. For example, exemplary embodiments search to locate documents associated with the at least one document attribute received at block 401. The searching may include retrieving status information from the currently open documents from the source code executing on the processor, or alternatively, from binary flags stored alongside a temporary file associated with the document. All such alternatives are intended to be within the scope of exemplary embodiments.

The method 400 further includes organizing a first attribute group based on results of the searching at block 403. The organizing may include categorizing documents associated with the at least one document attribute and grouping the categorized documents as the first attribute group. For example, organizing documents may be considered categorizing documents. Thereafter, the method 400 includes graphically representing the first attribute group as a group of application-specific documents. The graphical representation may be a list including the first attribute group, a tab-interface including the first attribute group, a completely graphical representation segregated based on attributes, or other similar representations. Therefore, exemplary embodiments of the present invention provide a method of organizing application-specific documents based on document attributes.

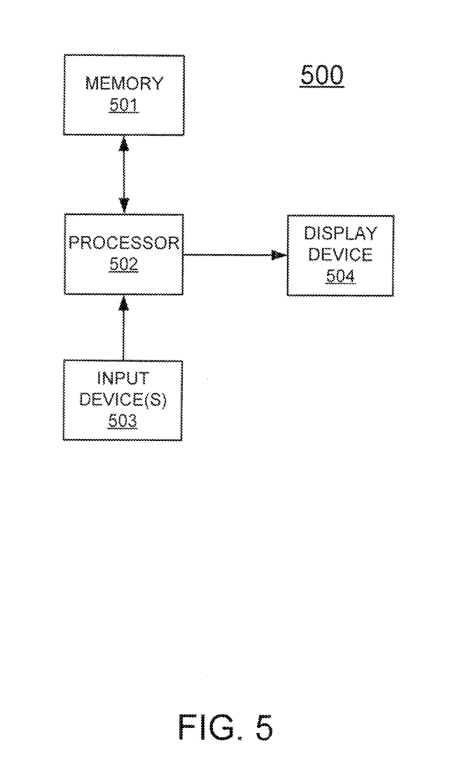

Furthermore, according to an exemplary embodiment, the method described hereinbefore may be implemented by a computer system or apparatus. For example. FIG. 5 illustrates a computer apparatus for attaching documents, according to an exemplary embodiment. Therefore, portions or the entirety of the method may be executed as instructions in a processor 502 of the computer system 500. The computer system 500 includes memory 501 for storage of instructions and information, input device(s) 503 for computer communication, and display device 504. Thus, the present invention may be implemented, in software, for example, as any suitable computer program on a computer system somewhat similar to computer system 500. For example, a program in accordance with the present invention may be a computer program product causing a computer to execute the example method described herein.

The computer program product may include a computer-readable medium having computer program logic or code portions embodied thereon for enabling a processor (e.g., 502) of a computer apparatus (e.g., 500) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs. ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

While an exemplary embodiment has been described, it will be understood that those skilled in the art, both now and in the future, may make various improvements and enhancements which fall within the scope of the claims which follow. These claims should be construed to maintain the proper protection for the invention first described.

What is claimed is:

1. A method of organizing application-specific documents of a computer system, comprising:
receiving a user-based selection of at least one document attribute through an application residing on a processor of the computer system;
searching currently open documents within the application to locate documents associated with the at least one document attribute, wherein searching includes retrieving status information from the currently open documents;
organizing a first attribute group based on results of the searching, wherein organizing includes categorizing documents associated with the at least one document attribute and grouping the categorized documents as the first attribute group; and
graphically representing the first attribute group as a group of application-specific documents; wherein the at least one document attribute includes one of,
documents modified and not stored in the application,
documents modified from a point of opening within the application, and
documents that arc write-protected or read-only.

2. The method of claim 1, further comprising:
receiving a user-based selection of a second document attribute through the application;
searching currently open documents within the application to locate documents associated with the second document attribute, wherein searching includes retrieving status information from the currently open documents;
organizing a second attribute group based on results of the searching, wherein organizing includes categorizing documents associated with the second document attribute and grouping the categorized documents as the second attribute group; and
graphically representing the second attribute group as a group of application-specific documents separate from the graphical representation of the first attribute group.

3. The method of claim 1, wherein graphically representing the first attribute group includes providing a graphical listing of documents in the first attribute group.

4. The method of claim 1, wherein graphically representing the first attribute group includes providing a tab-interface including user-selectable tabulated lists of documents in the first attribute group.

5. The method of claim 1, wherein graphically representing the first attribute group includes providing a segregated grid divided into portions populated by document attribute groups with at least one portion including the first attribute group.
